(19) United States
(12) Patent Application Publication
(10) Pub. No.: US 2006/0011455 A1
(43) Pub. Date: Jan. 19, 2006

(54) Conveyor

(76) Inventor: Erik S. Petersen, Hojbjerg (DK)

Correspondence Address: HANLEY, FLIGHT & ZIMMERMAN, LLC, 20 N. WACKER DRIVE, SUITE 4220, CHICAGO, IL, 60606, US

(21) Appl. No.: 11/045,879

(22) Filed: Jan. 28, 2005

(30) Foreign Application Priority Data
Jan. 30, 2004 (EP) 04 002 081.0
Sep. 10, 2004 (EP) 04 021 518.8

(51) Int. Cl. B65G 21/14

(52) U.S. Cl. 198/812

(57) ABSTRACT

A conveyor comprises a base conveyor section, at least one moveable conveyor section selectively positionable relative to the base conveyor section, a conveyor member arranged to provide a conveying surface on said conveyor sections, a drive system to drive the movable conveyor section and/or the conveyor member, and a contact sensor connected to a control device for interrupting the movement of the conveyor member and/or the movable conveyor section in response to a signal generated by the contact sensor, wherein said contact sensor comprises an actuation element adapted to transfer both vertical and horizontal contact forces to said contact sensor.

### RELATED APPLICATIONS

This application claims the benefit of the filing dates of European Application Nos. 04 002 081.0, filed on Jan. 30, 2004, and 04 021 518.8, filed Sep. 10, 2004, the disclosures of which are hereby incorporated by reference in their entireties.

### TECHNICAL FIELD

The present disclosure relates generally to conveyors, such as telescopic belt or roller conveyors, and more particularly, to conveyors with a base conveyor section and at least one moveable conveyor section selectively positionable relative to the base conveyor section or the next inner conveyor section.

### BACKGROUND

Conveyors of the type mentioned above are known and used in the art. For example, U.S. Pat. No. 4,643,299 discloses a telescopic belt conveyor comprising a first basic conveyor section within a longitudinal housing, which at one end is provided with an opening, through which a number, by way of example two, three or more, of telescopic conveyor sections are arranged within each other. These telescopic conveyor sections may be telescopically moved in and out in relation to each other, as the conveyor sections are mutually connected by means of a suitable system of drive members, such as drive chains, and in relation to said basic conveyor section, which is provided with a common drive system for controlling the telescopic movement.

In U.S. Pat. No. 3,835,980 a telescopic belt conveyor structure is disclosed having limit switches mounted at the free end of an outermost extendable boom section. These limit switches are actuated by a plate attached at the boom section when the plate engages an obstacle as the boom section is being extended. When the switch is actuated the movement of the conveyor booms is stopped.

However, the known extendable or telescopic conveyors are encumbered with some disadvantages which may cause serious working accidents. There is a risk, especially during the telescopic movement of the respective telescopic conveyor sections that personnel may get hands or fingers squeezed between the respective conveyor sections. Another potential risk is that the drive chains of the intermediate conveyor sections, when the undersides these sections are exposed during outward and inward movements, may cause damages especially to hands and fingers.

### BRIEF DESCRIPTION OF DRAWINGS

FIG. 1 shows a schematic plane side view of the course of an endless conveyor belt in an example for a telescopic belt conveyor.

FIG. 2 shows a corresponding side view of an outer part of the telescopic belt conveyor shown in FIG. 1.

FIG. 3 shows a simplified side view of an example of a telescopic belt conveyor with partly extended conveyor sections.

FIG. 4 shows a plane schematic side view of an example for a telescopic belt conveyor—shown with the telescopic conveyor sections in a retracted position.

FIG. 5 shows a corresponding plane view of the course of drive chains between the respective telescopic conveyor sections shown in a partly extended position in relation to a basic conveyor section.

FIG. 6 shows a side view of an outermost part of the telescopic belt conveyor shown in FIG. 4 in an extended position.

FIG. 7 shows a simplified side sectional view through an outermost part of the belt conveyor position of FIG. 4 in a retracted position.

FIG. 8 shows an enlarged view of an indicated circular section in FIG. 7.

FIG. 9 shows a simplified transverse sectional view through an outermost part of the telescopic belt conveyor of FIG. 4.

FIG. 10 shows an enlarged view of an indicated circular section in FIG. 9.

FIG. 11 shows a schematic detailed view of a pivot switch at the front end of said intermediate conveyor sections and said basic conveyor section in a telescopic belt conveyor.

FIG. 12 shows a schematic detailed view of a contact sensor at the outermost conveyor section of a telescopic belt conveyor.

FIG. 13 shows a simplified side view of another example of a telescopic belt conveyor with partly extended conveyor sections.

FIG. 14 shows a plane schematic side view of an example for a telescopic belt conveyor shown with the telescopic sections in a retracted position.

FIG. 15 shows a corresponding plane view of the course of drive chains between the respective telescopic conveyor sections shown in a partly extended position in relation to a basic conveyor section.

FIG. 16 shows a transverse sectional view through said example for a telescopic belt conveyor.

FIG. 17 shows a side view of an alternative example for a telescopic belt conveyor.

FIG. 18 shows a side view of a further preferred example for a telescopic belt conveyor.

FIG. 19 shows a side view of an example for a short individually-adjustable front belt conveyor section for a telescopic belt conveyor.

FIG. 20 shows a perspective view of a front nose part of either a telescopic belt conveyor cf. FIG. 17 or an adjustable front belt conveyor cf. FIG. 19.

FIG. 21 shows a detailed side view—partly in section—of the actuation element of the front nose part of FIGS. 19 and 20.

### DESCRIPTION OF PREFERRED EXAMPLES

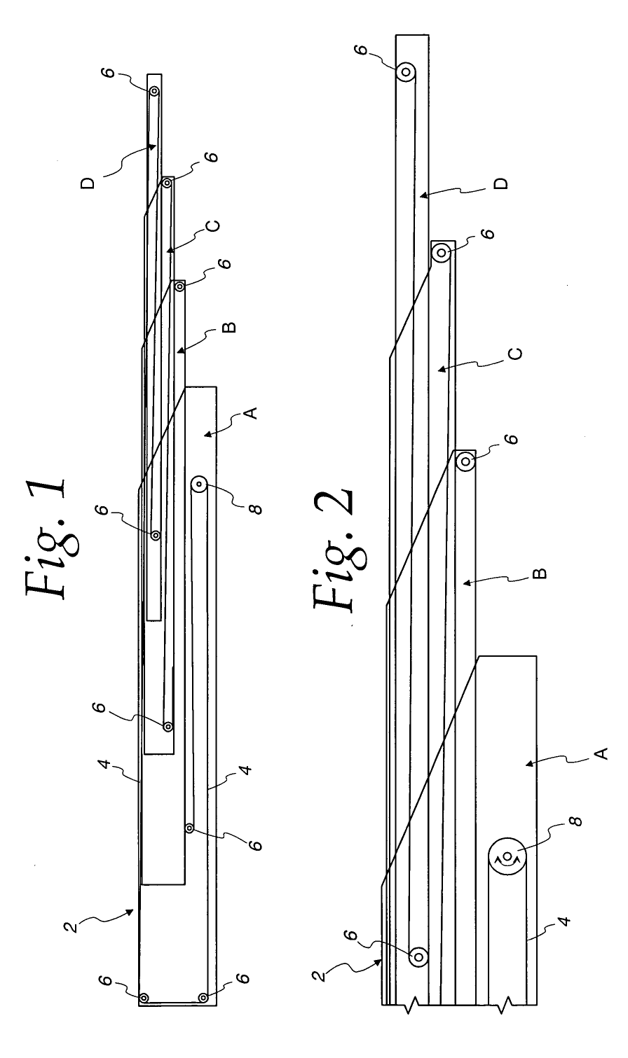

FIG. 1 shows a side view of an example of a conveyor: a telescopic belt conveyor. However, before proceeding further with the detailed description of FIG. 1, a few items of some of the preferred examples will be discussed.

In these examples, a contact or an impact of at least one of the moving parts of a conveyor during its operation with the environment, e.g. a person, a vehicle, etc., is detected. For preventing damages due to such contacts the conveyor is provided with one or more contact sensors which are adapted to detect both horizontal and vertical as well as in between lying contact or impact forces, i.e. horizontal and/or vertical forces. The contact sensor may be a single element or group of cooperating elements and may be disposed at various places at the moveable conveyor as well as may be of various types, such as electrical or mechanical switches.

In an example the conveyor comprises a base conveyor section, which, e.g. can be mounted on a floor or can be moveable on tracks, rollers, etc., one or more moveable sections and a conveyor member arranged to provide a conveying surface on the conveyor sections. Such conveyor member is, for example, provided by an endless conveyor belt or conveyor rollers.

In some examples the moveable conveyor sections are extendable conveyor sections which are extendable or telescopically moveable between a retracted position and an extended position relative to the next inner extendable conveyor section or the base conveyor section. In other examples the moveable conveyor section is attached to a conveyor section and adapted for a pivotal movement relative thereto. Also a combination of both types of movable conveyors sections is possible. For example, in another example the pivotally moveable section is mounted at the free end of an outermost extendable conveyor section. In another example, on one end of the base conveyor section a pivotally moveable section is mounted and on the opposed end of the base conveyor section at least one extendable conveyor section is mounted. Alternatively, on both sides of the conveyor a pivotally moveable section is mounted, i.e. on one side of the base conveyor section and on the other side on the outermost extendable conveyor section.

In another example the base conveyor section and therefore the whole conveyor is pivotally movable in upward and downward directions. For instance, on one side of the base section hydraulic or pneumatic cylinders are mounted which are adapted to lift or lower the base conveyor section resulting in an inclined position of the conveyor surface.

In the examples at least one drive system arranged to drive at least one of the moveable conveyor sections and the conveyor member is provided. The drive system comprises, for example in case of the extendable conveyor sections, drive chains which mutually connect the extendable conveyor sections and are driven by an electric drive motor located in the base section or in the next outer extendable section. The pivotally moveable conveyor section may be driven, for example, by a hydraulic or pneumatic cylinder or by an electric device. The conveyor belt or the conveyor rollers are driven independently from the moveable conveyor sections, e.g. by an additional electric drive motor. In these examples the movements of both the conveyor member and the moveable conveyor sections are controlled by a control device which is adapted to interrupt the movement of at least one of the conveyor member and the at least one movable conveyor section, such as the outermost extendable or pivotable conveyor section, in response to a signal generated by a contact sensor. In another example brakes or a brake system are arranged to interrupt at least one of the conveyor member and the moveable conveyor section movement and are controlled by the control device. The brake system may comprise an electric brake device, for example, which is adapted to engage when a conveyor section movement is stopped at least by power failure, chains braking, sensing operational failures of the conveyor or by an operator's activity. In another example the brake is adapted to be biased closed and actuated to a release position only when power is available and an operator deliberately activates a switch.

In some examples the contact sensor comprises at least one touch-activated actuation element for transferring both vertical and horizontal contact forces to the contact sensor. In this example the contact sensor comprises at least one electric switch which is directly activated by the movement of an associated actuation element. The actuation element may be a single member or group of members cooperating in such a manner to transfer both vertical and horizontal contact forces to the contact sensor.

In a preferred example the actuation element is formed such that it provides a contact surface for receiving forces from both the vertical and horizontal directions. Preferably this is achieved by, e.g. a wall or shield part which is mounted for allowing pivotal movement in respect to the contact sensor. Preferably, the wall or shield part is mounted at one side of the base section where the movable section is arranged. When, for example, a user engages the underside of the movable section with his hand or fingers during a retraction movement of the movable section, the actuation element receives the basically horizontal contact force of the hand or the fingers. In response the contact sensor generates a signal and the control device interrupts the movement of the movable section in response to the generated signal. In another preferred example the actuation element has a semi-circular shape. In this example the semi-circular actuation element is, for example, pivotally mounted at an upper transverse axis. By this way—due to the shape and the upper transverse displaced pivot axis—the semi-circular actuation element transfers both horizontal and vertical forces or any combination thereof into a corresponding rotational-like movement. As explained above, due to the movement of the actuation element the contact sensor generates a signal and the control device stops the movement of at least one of the movable section and the conveying member in response to the signal. In still another example the actuation element provides additional shielding and protection function due to its shape or mounting position at the moveable conveyor section and, e.g. comprises a semi-circular shield part.

In another example the actuation element additionally comprises a control box for controlling the conveyor. Such control functions are, for example, start and stop instruction of the movement of the movable conveyor section as well as of the conveyor member, an emergency stop, a joystick for controlling the movement of the pivotally movable section or of the base section, switches for turning on/off lights, hydraulic pumps, etc. In another example the actuation element additionally comprises openings for transmitting light emitted from a light source which is, e.g. also mounted in the actuation element.

In another example the actuation element comprises a transverse elongate nose part on an outermost end of the movable conveyor section which is enabled to be pressed in at least one of an upward and inward direction against one or more compression springs by an upwardly or inwardly directed compression impact. In still another example the nose part can additionally comprise openings and a light source mounted behind said openings and inside of the nose part.

In another example the conveyor further comprises a short belt conveyor section at an outermost or front position being adapted to swing relative to the base conveyor section or to the next inner conveyor section. In this example the actuation element is preferably mounted at the outermost end of the short belt conveyor section.

In some examples the actuation comprises end flanges which are arranged in bearing holes mounted at the outermost end of the movable conveyor section. For instance, in a preferred example the elongate nose part, explained above, is mounted by this way. In this example the actuation element is—due to the above explained mounting—adapted to be displaced in both vertical and horizontal directions and to activate said contact sensor. As mentioned above, such contact sensor comprises in some examples an electric switch which is activated by a movement or displacement of the actuation element.

In the examples one or more actuation elements may be placed in different locations at the moveable conveyor or base conveyor sections. For instance, in a preferred example the actuation element is mounted at the outermost end of the outermost of the at least one movable conveyor section. In this example the actuation element is displaced when receiving a contact force during the movement of the moveable conveyor section or of the base section, e.g. when a user gets his foot under a pivotally movable conveyor section or when a personnel loading or unloading a truck is squeezed by an extending conveyor section.

In another preferred example the actuation element extends over the whole width of the movable conveyor section.

Returning now to the specific example of FIG. 1, the telescopic belt conveyor 2 comprises four sections, namely a basic section A, two intermediate sections B and C and an outermost section D. The sections B, C and D may be moved in and out in a telescopic manner in relation to each other and in relation to the basic section A. The belt conveyor 2 comprises an endless conveyor belt 4, which (cf. FIGS. 1 and 2) is lead around a number of stationary reversing rollers 6 in the respective sections A-D, and which is driven by a common, reversible drive roller 8, which is positioned in section A, and which is driven by a motor, illustratively an electric driving motor, although hydraulic or other motor types could be used.

The telescopic movement of the sections B-C may be carried out in a variety of ways.

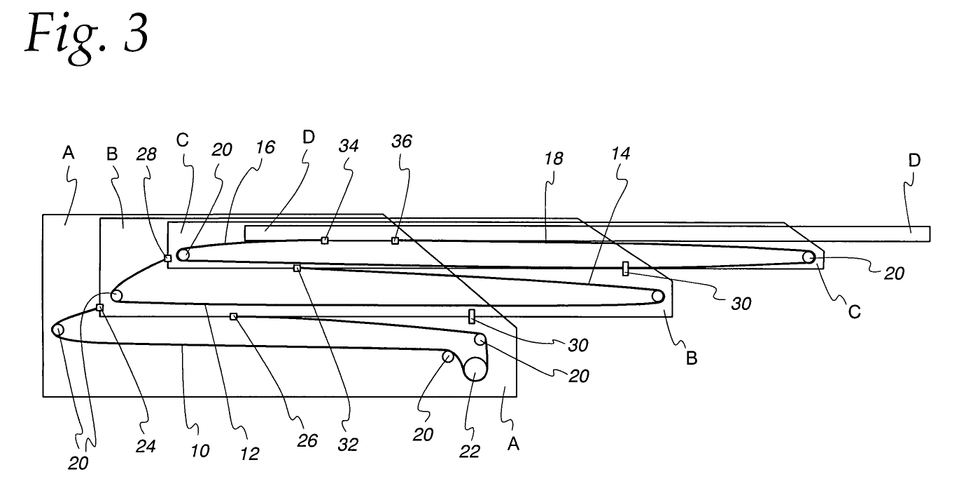

In FIG. 3 a schematic view of the telescopic belt conveyor is shown. In this example the conveyor sections are moved by chains 10, 12, 14, 16, and 18, respectively. The chains run over a stationary sprocket wheels 20 and only chain 10 is driven by a wheel 22 connected to a motor. The chain 10 runs in the basic section A and is connected at its ends on the next outer conveyor section B at connection points 24 and 26, while the chains 12 and 14 run in an ellipse-like course in conveyor section B and are mounted at its ends on conveyor section C at connection points 28 and 32. Chains 14 and 18 which move section D run in a similar fashion. By this way of connecting the single conveyor sections to each other, the drive force of chain 10 is carried over the other chains 12, 14, 16 and 18 and the conveyor sections B, C and D are moved simultaneously inwardly or outwardly. Chains 12 and 16 move the conveyor sections C and D backwards and chains 14 and 18 forwards. In this example the chains 12 and 14 are connected together as well as chains 16 and 18 at a common anchor point 30 where, additionally, a bracket or chain mounting is mounted. This bracket is mounted on the base section A (or section B, respectively) and raises the chain at the common anchor point 30 of the corresponding chains 12, 14 and 16, 18. Additionally In another example the forward leading chains are raised by corresponding sprocket wheels 20, which are in a raised position, too.

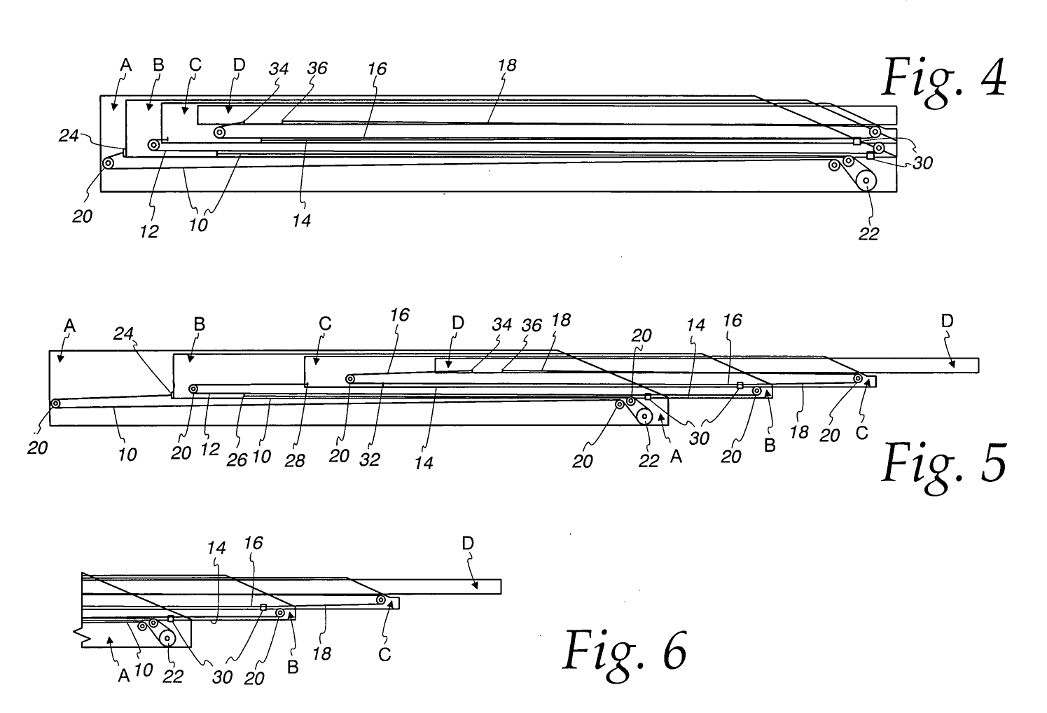

FIGS. 4-6 show a more detailed view of the telescopic belt conveyor of this example. The movement of the conveyor sections is carried out by means of elongated drive members in the form of chains 10, 12, 14, 16 and 18, which are disposed at opposite long sides of the belt conveyor 2. The drive chains 10, 12, 14, 16 and 18 run between the respective sections A-D around stationary sprocket wheels, as opposite ends of each of the drive chains 10, 12, 14, 16 and 18 are anchored to two sections. The drive chains 10 are furthermore led around driving sprocket wheels 22, which are placed in the front end of section A, and which are driven by means of a reversible electric driving motor (not shown). End parts of the drive chains 10 are anchored at 24 to a rearmost end part of section B, from where the drive chains 10 are led around stationary sprocket wheels 20 into the rearmost end of the basic section A and forward around a second stationary sprocket wheels 20, around the drive sprocket wheels 22 and back again a third around stationary sprocket wheels 20 to anchor points 26 at the underside of section B some distance in front of the rearmost end of section B.

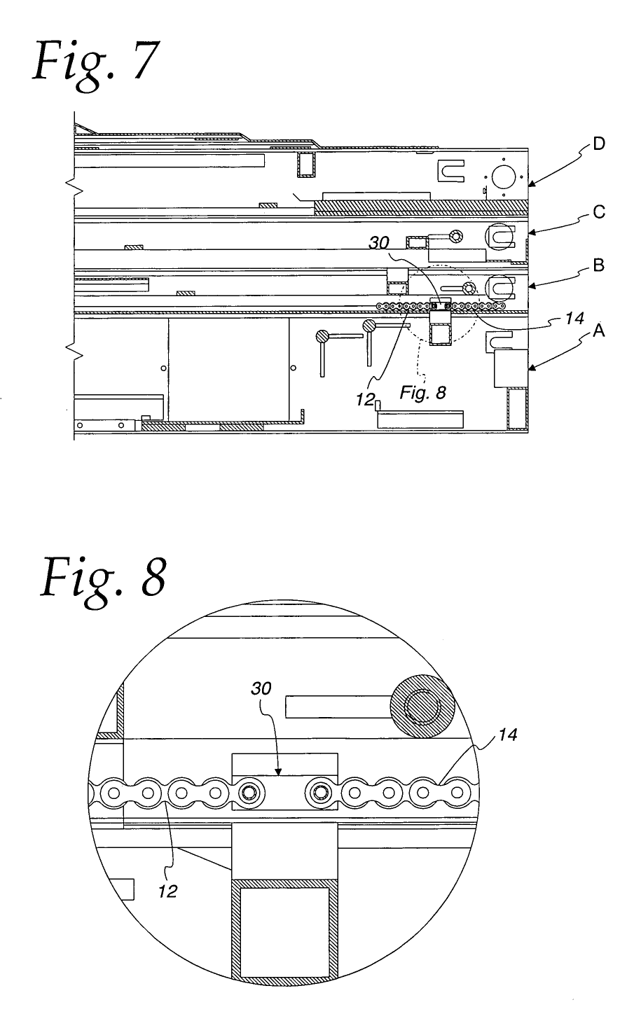

Similarly, end parts of the drive chains 12 are rearmost in section C anchored at 28, from where the drive chains 12 are led around stationary sprocket wheels 20 placed in the rearmost end of section B and forward to the rear sides of cranking chain mountings 30 (FIG. 7) in the front end of basic section A. End parts of the drive chains 14 are anchored to the front side of the same chain mounting 30 in the front end of basic section A, from where the drive chains 14 are led forward and around stationary sprocket wheels in the front end of section B and again backwards to anchor points 32 on the underside of section C some distance in front of the anchor points 28.

In a similar manner, end parts of the drive chains 16 are anchored at 34 rearmost in section D, from where the drive chains 16 are led backwards around stationary sprocket wheels placed rearmost in section C and again forward to the rear sides of cranking chains mountings 30 in the front of section B. End parts of the drive chains 18 are anchored to the front sides of the same chain mounting 30 in the front of section B, from where the drive chains 18 are led forward and around stationary sprocket wheels 20 in the front end of section C and again led backwards to anchor points 36 on the underside of section D some distance in front of the anchor points 34.

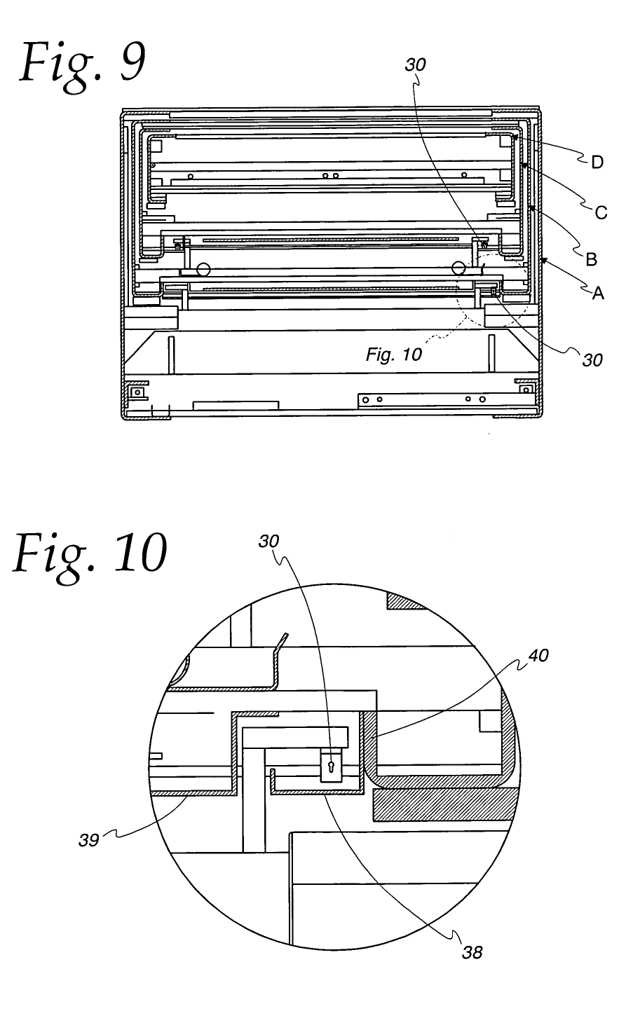

FIGS. 7-10 show the position and more details about the cranking chain mountings 30 as discussed above, which are placed in the front ends of sections A and B, and which are used for the anchoring of end parts of the drive chains 12, 14, 16 and 18. Furthermore, the examples of FIGS. 9 and 10 show longitudinal coverings 38 for the lower course of the drive chains 14 and 18 by the intermediate sections B and C. These longitudinal coverings 38 are at both sides of the belt conveyor 2 suspended at the inside of longitudinal carrying girders 40 of the intermediate sections B and C.

In this example the longitudinal coverings are made possible by the configuration of cranking mountings 30, which serve to raise the lower runs of chains 12, 14, 16 and 18 above their conventional positions without chain mountings 30. Without this raising of the lower runs of the chains, the longitudinal coverings would not be possible, as they would be in an interfering position between sections such as would prevent proper telescopic operation.

In a preferred example, the entire underside of each of the telescopic conveyor sections results to be closed or covered by the combination of the chain guard 38 and the belt guard 39—as shown to the left of FIG. 10. The raised anchor points 30 for the chains allows the chain guard 38 to be positioned as it is, and fills the side gap that used to exist where the belt guard 39 ended and the unguarded chains ran. The combination of the chain guard 38, the bracket for holding mountings 30 and the belt guard 39 present what is in effect a closed bottom, although not the complete closed bottom of the preferred example.

In these examples the respective conveyor sections B, C and D in relation to each other and in relation to the basic conveyor section—as per se known—are supported and guided in the transverse direction by means of stationary rollers provided with external guiding flanges, which cooperate with longitudinal carrying girders.

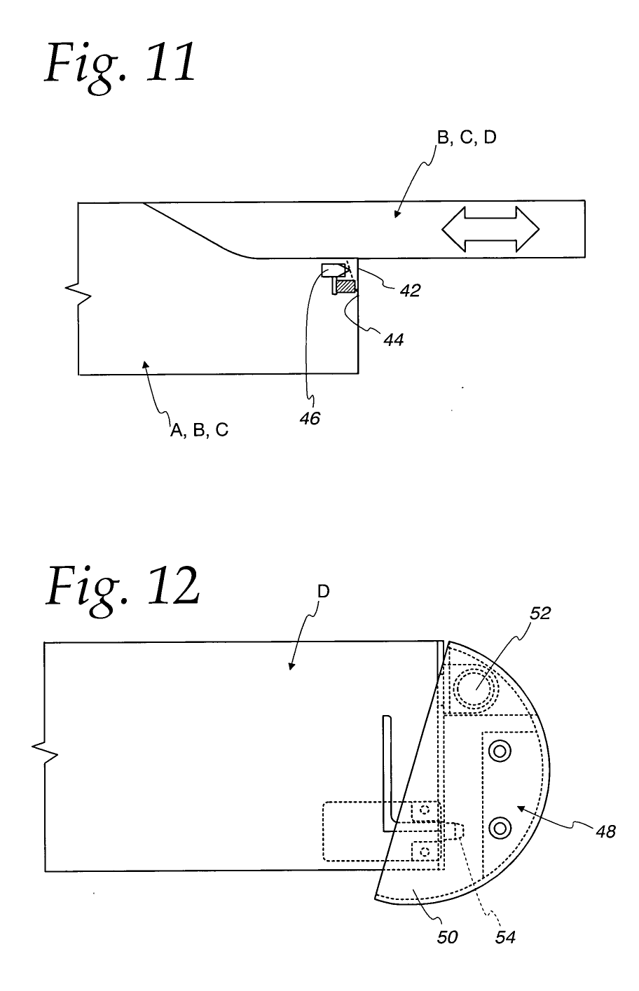

FIG. 11 shows a schematic detailed view of an example of a front end part of the sections A, B or C where an actuation element in the form of an upper transverse plate part 42 is provided on a lower hinge 44 so that the plate part 42 is able to be swung inwardly enabling it to get into contact with an electric switch 46. The telescopic movement of the sections B, C and D is then at once interrupted by the control device in response to a signal received from said electric switch 46. The plate part 42 is spring activated or biased to return to its normal vertical position, when an item, finger or hand of a use, which has caused the emergency stop is removed and the electric switch has been closed again.

FIG. 12 shows a schematic detailed view of an actuation element of another preferred example. The actuation element is disposed at the outermost end of section D in the form of a transverse shield 48 having a semi-circular cross-section and semi-circular end walls 50. The length of the shield 48 extends over the whole width of the conveyor section D. The shield 48 is a unit pivotally suspended around an upper transverse axis 52 such that the shield 48 can be swung inwards/upwards against a number of compression springs, whereby the shield 48 will engage an electric switch 54. A control device instantly stops any telescopic movement and/or a possible tipping movement in response to a signal received from the electric switch 54, if the belt conveyor 2 also has a vertical tipping function of one or more conveyor sections.

In still another example shield 48 is arranged in such a manner that it is displaceable in the transverse direction in relation to the outer end of the conveyor section D and that such a transverse displacement of the shield 48 in relation to the outer end part of section D would activates an electric switch and the control system causes interruption of any transverse swinging movement of the outer end of conveyor section D in response to a signal received from the electric switch.

In the above examples, due to its shape and suspension the shield 48 also acts as a switch for downward directed forces so that a possible downward tipping movement of the outermost section is instantly interrupted, if a person, for example, gets a foot squeezed under the front end of the outermost section D.

The arched front side of the shield 48 is advantageously provided, e.g. with openings, so that a light source positioned inside the shield 48 lights the area outside the front end of the belt conveyor 2. This is in particular advantageous if the belt conveyor is lead into the truck body for the loading or unloading of goods or parcels.

In another example, in the arched front side or in a plane side wall of the shield 48 a control box is built-in with push-button switches for operation of said light source and the respective drive motors of the telescopic belt conveyor for start/stop of the conveying belt and of the telescopic movement of the conveyor sections.

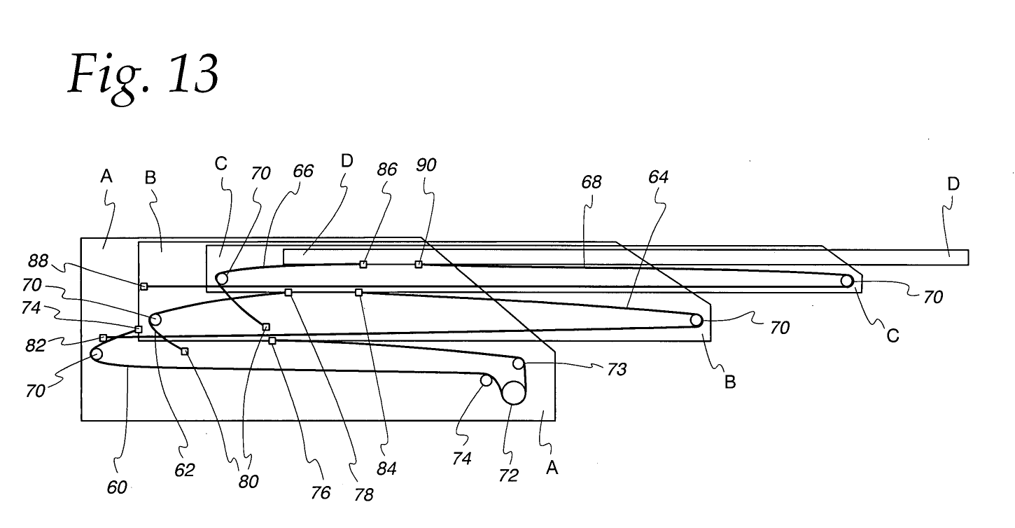

In one example for a telescopic belt conveyor 56 the course of the endless conveyor belt 4 is in principle just the same as shown in FIGS. 1 and 2, while the course of the respective drive chains as shown in FIGS. 13-16 is indeed different than that of the course of the drive chains 10, 12, 14, 16 and 18 by the telescopic belt conveyor 2 as described above with reference to FIGS. 3-10.

The telescopic belt conveyor 56 comprises four sections, namely a basic section A, two intermediate sections B and C and an outermost section D. The sections B, C and D may be moved in and out in a telescopic manner in relation to each other and in relation to the basic section A. The belt conveyor 56 comprises an endless conveyor belt 4, which cf. FIGS. 1 and 2 is lead around a number of stationary reversing rollers 6 in the respective sections A-D, and which is driven by a common, reversible drive roller 8, which is positioned in section A, and which is driven by a motor such as an electric or hydraulic driving motor.

The drive chain configuration according to this example is schematically shown in FIG. 13. The forward- and backward-leading chains 60, 62, 64, 66, and 68, as shown in FIG. 13, are separate and separately mounted. The forward leading chains 64 and 68 extend through an open rear wall of the conveyor sections B and C, respectively. At one end the forward leading chain 64 is mounted on conveyor section C at position 84 and on the rear end of conveyor section A at position 82. Similarly, the ends of chains 68 are mounted on conveyor section D at position 90 and on the rear end of conveyor section B at position 88. The mounting points 82 and 88 are at such a height that the forward-leading chains 64 and 68 do not cross the bottom of the corresponding conveyor sections B and C, respectively. The backward-leading chains are guided through the bottom at the rear end of conveyor sections B and C. The other end points of the backward-leading chain 62 are mounted in the base conveyor section A at position 80 and on conveyor section C at position 78. Similarly, the end points of the backward leading chain 66 are mounted at position 80 in conveyor section B and at position 86 on conveyor section D.

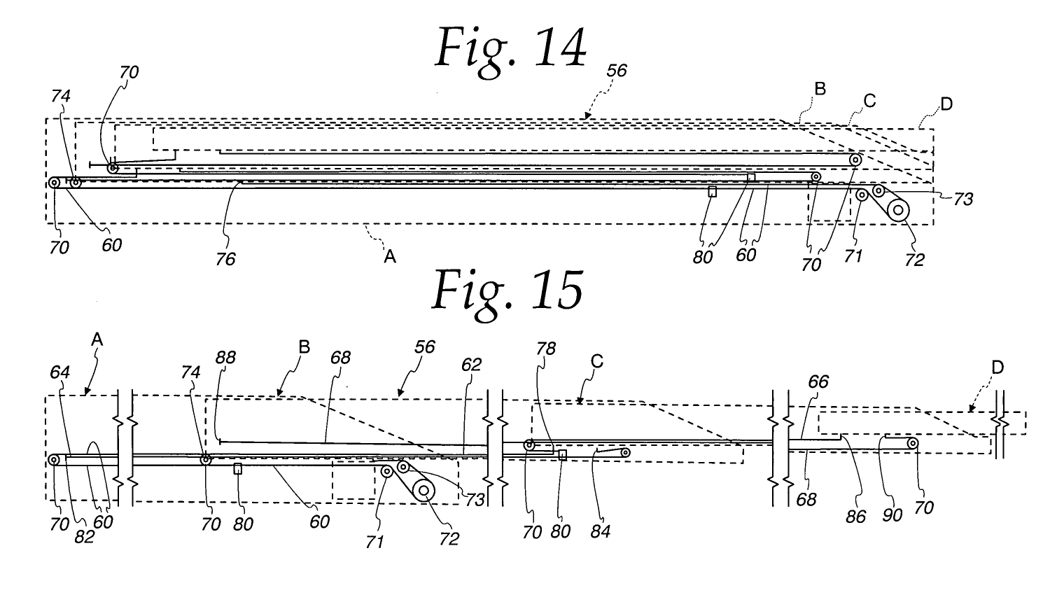

FIGS. 14 and 15 show a detailed view of the example. The telescopic movement of the sections B-C is carried out by means of drive chains 60, 62, 64, 66 and 68, which are disposed at opposite longitudinal sides of the belt conveyor 56 and run between the respective sections A-D around sprocket wheels mounted stationary in the respective sections A-D, as opposite ends of each of the drive chains 60, 62, 64, 66 and 68 are anchored to two sections. The drive chains 60 are furthermore led around driving sprocket wheels 72, which are placed in the front end of section A, and which are driven by means of a (not shown) reversible electric or other driving motor. End parts of the drive chains 60 are anchored at 74 to a rearmost end part of section B, from where the drive chains 60 are led around stationary sprocket wheels 70 into the rearmost end of the basic section A and forward around stationary sprocket wheels 71, around the drive sprocket wheels 72 and back again around stationary sprocket wheels 73 to anchor points 76 on the underside of section B some distance in front of the rearmost end of section B.

End parts of the drive chains 62 are rearmost in section C anchored at 78, from where the drive chains 62 are led around sprocket wheels 70 mounted on the rearmost wall section B and forward to chain mountings 80 in the front end of basic section A. End parts of the drive chains 64 are anchored near the rearmost end of section A at 82, from where the drive chains 64 are led forward and around stationary sprocket wheels 70 in the front end of section B and again backwards to anchor points 84 on the underside of section C some distance in front of the anchor points 78.

End parts of the drive chains 66 are anchored at 86 rearmost in section D, from where the drive chains 66 are led backwards around sprocket wheels mounted 70 on the rearmost wall of section C and again forward to chains mountings 80 in the front of section B. End parts of the drive chains 68 are anchored near the rearmost end of section B at 88, from where the drive chains 68 are led forward and around stationary sprocket wheels 70 in the front end of section C and again led backwards to anchor points 90 on the underside of section D some distance in front of the anchor points 86.

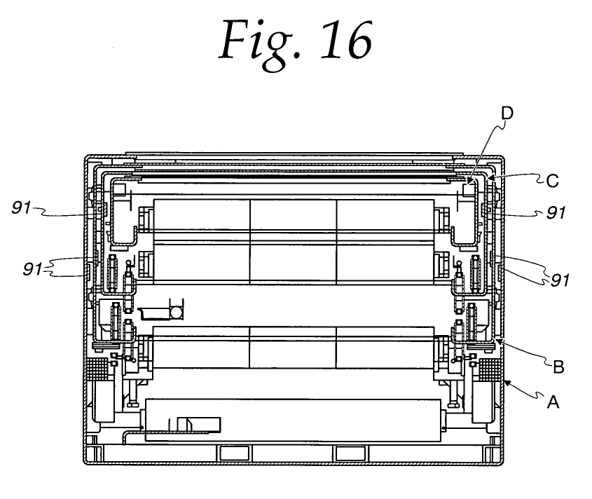

The example of FIG. 16 shows that the various sprockets wheels 70 may be offset laterally to achieve the orientation of the chains shown in FIGS. 14 and 15.

One of the benefits of the drive chains in this preferred example is that there is basically an absence of chain runs (top or bottom) passing through the plane defined by the bottom of sections B, C or D, or at least the parts thereof exposed during telescopic movement. As a result, the undersides of these sections or at least the parts of the undersides exposed during the telescopic movement may be provided with closed coverings preventing any possible penetration into the underside of the sections and thus preventing accidents causing damage to hands, fingers or other body parts of the user, which could otherwise be damaged or injured by engaging said undersides during said telescopic movement.

In this example, this benefit is obtained by the fact that the anchor points of the drive chains, such as anchor points 82 and 88 for drive chains 64 and 68, respectively, are disposed at a suitable height to allow their bottom runs to be led through the opening in the rear of sections B and C and to stay above the undersides thereof. Further, the sprocket wheels 70 mounted at the rearmost walls of sections B and C and at the bottom thereof make it possible that the drive chains 62 and 66 may also be led through openings in the rear walls of sections B and C, and then have a lower run below the underside of the respective sections, but only in an area that will not be exposed during the telescopic movements. Accordingly, the undersides of these sections or at least the parts of the undersides exposed during the telescopic movements may be provided with coverings.

In the example of FIG. 16 the aforementioned brakes between the respective telescopic conveyor sections A-D are designated as 91. Preferably the brakes 91 for braking the mutual telescopic movement between the basic conveyor section A and the intermediate conveyor section B are mounted on the outer basic conveyor section A.

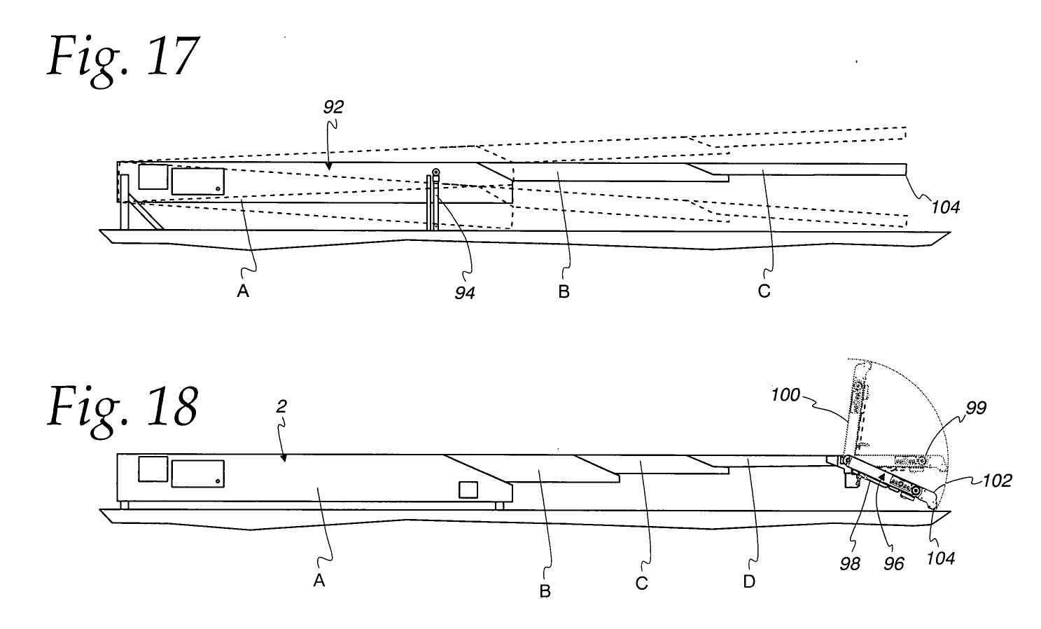

FIG. 17 shows an alternative example for a telescopic belt conveyor 92 wherein the basic section A of the telescopic belt conveyor 92 at opposite sides is provided with one or more adjustment cylinders 94. With these adjustment cylinders 94 the conveyor as a whole can be tipped between a raised and a lowered position of the front end section C of the telescopic belt conveyor 92 in order to make it easier to load heavy loads onto the front end section C—e.g. when loading or unloading lorries, trucks or the like.

Alternatively, as shown in FIG. 18, the outermost telescopic section D of the telescopic belt conveyor 2 is provided with a particular short front belt conveyor 96 (so called “droop snoot”), which can be pivoted between an raised position 100 and a lowered position 102 and any positions in between by a hydraulic or pneumatic operated cylinder 98 in order to facilitate unloading or loading of heavy loads from or onto the front end section D of telescopic belt conveyor 2—when, for example, unloading or loading lorries, trucks or the like. The short front belt conveyor 96 has a separate conveyor belt 99 providing an adjustable conveying surface.

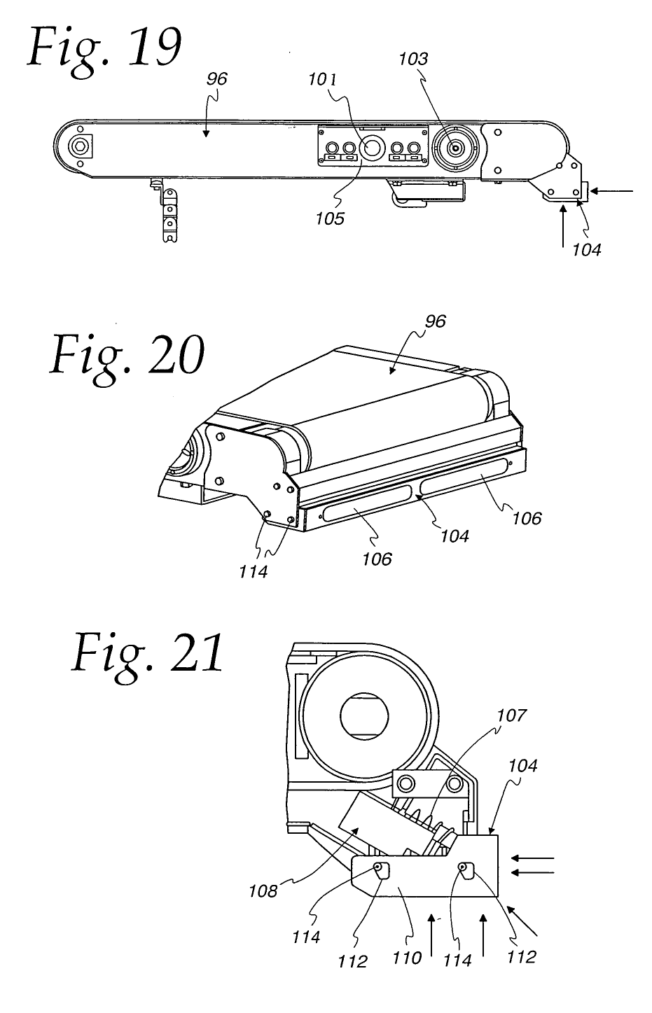

FIG. 19 shows a side view of an example of the said short individual adjustable front belt conveyor 96 which at a front end is provided with an actuation element in the form of a transverse elongated nose part 104, which can be pressed upwards and/or inwards against one or more compression springs 107 by an upwardly or inwardly directed compression impact. As in the examples, said nose part 104 interacts with said electrical switch 108 which sends a signal to the control device. In another example the actuation element 48 according to the examples discussed above may also be arranged at the free end of the belt conveyor 96.

At least one side of the front belt conveyor 96 is provided with a control panel 105 comprising even a joy stick 103 for operating the telescopic and/or tipping movement of the respective sections of the telescopic belt conveyor controller. And the control panel 105 also comprises an emergency stop switch 101 together with more switches, e.g. for turning on/off light sources, hydraulic pumps etc.

Furthermore the telescopic belt conveyor 92 is provided such that said nose part 104 in a forward surface may be provided with openings 106, and that a light source is mounted inside said nose part 104, which is also shown in FIG. 20.

In principle, the touch activated actuation element in the form of the transverse nose part shown in FIGS. 20 and 21 also represent the nose part 104 of the section C of the telescopic belt conveyor 92 shown in FIG. 17.

FIG. 21 shows in more detail the way how the transverse nose part 104 is arranged in a so-called floating manner as end flanges 110 provided with enlarged bearing holes 112 allow the nose part 104 as a whole to be displaced both in vertical and horizontal directions in relation to rigid bolts 114 against said one or more compression springs 107 and to activate said electrical switch 108. The electric switch 108 sends a signal when activated to a control device which in response to the signal interrupts the movement of at least one of the conveyor section and the conveyor belt.

Other examples also exist with drive chains on one side of the conveyor sections only and/or the drive chains or at least some of them are substituted by wire ropes and corresponding sprocket wheels are substituted by sheaves. Additionally some examples comprise only a base conveyor section and one moveable conveyor section.

In the preferred examples above, the configuration of the actuation element in combination with the contact sensor enables that any contact of the actuation element with, e.g. a user's hand, is sensed in horizontal as well as in vertical and all in between lying directions. This prevents to injure a user or personnel being near the conveyor when moving the conveyor sections or other parts of the conveyer, such as extendable or pivotally moveable sections. A further benefit of the configuration of the actuation element is the additional shield function of the actuation element due to its shape and/or position at the conveyor. Another benefit of the disclosed examples is that a light source can preferably be mounted in the actuation element and that openings in the actuation element allow the light to lighten a working area, e.g. in a dark loading area of a truck.

It is to be understood that the invention is not limited in its application to the details of construction and the arrangement of the components set forth in the above description or illustrated in the drawings. The invention is capable of including other examples or being carried out for similar conveyors having the same function. Also, it is to be understood that the phraseology and terminology employed herein are for the purpose of description and should not be regarded as limiting.

All publications and existing systems mentioned in this specification are herein incorporated by reference.

Although certain devices and products constructed in accordance with the teachings of the disclosure have been described herein, the scope of coverage of this patent is not limited thereto. On the contrary, this patent covers all examples of the teachings of the disclosure fairly falling within the scope of the appended claims either literally or under the doctrine of equivalents.

1. A conveyor comprising:
a base conveyor section,
at least one moveable conveyor section selectively positionable relative to the base conveyor section,
a conveyor member arranged to provide a conveying surface on said conveyor section,
at least one drive system arranged to drive at least one of the movable conveyor section and the conveyor member, and
a contact sensor connected to a control device for interrupting the movement of at least one of the conveyor member and the movable conveyor section in response to a signal generated by the contact sensor, wherein said contact sensor comprises at least one actuation element adapted to transfer both vertical and horizontal contact forces to said contact sensor.

2. The conveyor of claim 1, wherein the conveyor member comprises an endless conveyor belt.

3. The conveyor of claim 1, wherein the at least one conveyor section is adapted to move telescopically relative to the base conveyor section or the next inner conveyor section.

4. The conveyor of claim 1, wherein the conveyor section mounted at an outermost position is adapted to move pivotally relative to the base conveyor section or to the next inner conveyor section.

5. The conveyor of claim 4, wherein the outermost conveyor section is provided with a separate conveyor belt.

6. The conveyor of claim 1, wherein said actuation element is formed such that it provides a contact surface for receiving forces from both the vertical and horizontal directions.

7. The conveyor of claim 1, wherein said contact sensor comprises an electric switch.

8. The conveyor of claim 1, wherein said actuation element comprises a wall or shield part mounted for allowing pivotal movement in respect to the contact sensor.

9. The conveyor of claim 1, wherein said actuation element has a semi-circular shape.

10. The conveyor of claim 9, wherein said actuation element comprises a semi-circular shield part.

11. The conveyor of claim 10, wherein said semi-circular shield part comprises a built-in control box for controlling the conveyor.

12. The conveyor of claim 1, wherein said actuation element comprises openings for transmitting light emitted from a build in light source through said openings.

13. The conveyor of claim 1, wherein said control device for interrupting movements comprises an electric brake arranged to interrupt a movement of said conveyor sections.

14. The conveyor of claim 13, wherein said brake is arranged to engage when a conveyor section movement is stopped at least by power failure, chains braking, sensing contact, sensing operational failures of the conveyor or by an operator's activity.

15. The conveyor of claim 13, wherein said brake is arranged to be biased closed and actuated to a release position only when power is available and an operator deliberately activates a switch.

16. The conveyor of claim 1, wherein said actuation element comprises a transverse elongated nose part on an outermost end of the movable conveyor section which is enabled to be pressed in at least one of an upward and inward direction against one or more compression springs by an upwardly or inwardly directed compression impact.

17. The conveyor of claim 16, wherein said nose part comprises openings and a light source mounted behind said openings and inside of the nose part.

18. The conveyor of claim 1, further comprising a short belt conveyor section at an outermost or front position being adapted to swing relative to the base conveyor section or to the next inner conveyor section, wherein said actuation element is mounted at the outermost end of said short belt conveyor section.

19. The conveyor of claim 1, wherein the actuation element comprises end flanges which are arranged in bearing holes mounted at the outermost end of the movable conveyor section.

20. The conveyor of claim 19, wherein said actuation element is adapted to be displaced in both vertical and horizontal directions to activate said contact sensor.

21. The conveyor of claim 1, wherein the actuation element is mounted at the outermost end of the outermost of the at least one movable conveyor section.

22. The conveyor of claim 1, wherein the actuation element extends over the whole width of the movable conveyor section.
